(19) United States
(12) Patent Application Publication
(10) Pub. No.: US 2026/0239076 A1
(43) Pub. Date: Aug. 13, 2026

(54) TARGET CHANNEL STATE INFORMATION (CSI) BASED CHANNEL QUALITY INDICATOR (CQI)

(71) Applicant: Telefonaktiebolaget LM Ericsson (publ), Stockholm (SE)

(72) Inventors: Emil RINGH, Solna (SE); Xinlin ZHANG, Västra Frölunda (SE); Mattias FRENNE, Uppsala (SE)

(21) Appl. No.: 19/156,596

(22) PCT Filed: Feb. 14, 2024
(86) PCT No.: PCT/SE2024/050136

§ 371 Date: Aug. 14, 2025

Related U.S. Application Data
(60) Provisional application No. 63/485,779, filed on Feb. 17, 2023.

(51) Int. Cl. H04W 24/10

(52) U.S. Cl. CPC H04W 24/10

(57) ABSTRACT

A method, system and apparatus are disclosed. According to some embodiments, a wireless device is configured to communicate with a network node, where the wireless device configured to perform channel measurements, and generate a channel state information, CSI, report based on the channel measurements. The CSI report includes a channel quality indicator, CQI, that is based on a target CSI.

### TECHNICAL FIELD

The present disclosure relates to wireless communications, and in particular, to machine learning (ML)-based channel state information (CSI) reports.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

The 5^{th} generation mobile wireless communication system (e.g., NR) uses Orthogonal Frequency Division Multiplexing (OFDM) with configurable bandwidths and subcarrier spacing to efficiently support a diverse set of use cases and deployment scenarios. With respect to LTE, NR improves in deployment flexibility, user throughputs, latency and reliability. With NR comes also enhanced support for spatial multiplexing in which time-frequency resources are spatially shared across users, commonly referred to as Multi-User Multiple Input Multiple Output (MU-MIMO).

MU-MIMO operations is illustrated in FIG. 1 where a multi-antenna base station with N_{TX} antenna ports is spatially transmitting information to several wireless devices (e.g., UE), in which sequence S⁽¹⁾ is aimed for UE(1), S⁽²⁾ is aimed for UE(2), etc. Before modulation and transmission, precoding

$${W}_{V}^{( j )}$$

is applied to each sequence to spatially separate the transmissions, i.e., to mitigate multiplexing interference.

At receiver sides, each wireless device demodulates its received signal and combines receive antenna signals to obtain an estimate Ŝ⁽ⁱ⁾ of transmitted sequence. This estimate Ŝ⁽ⁱ⁾ can be expressed as

$${\hat{S}}^{( i )} = {\underbrace{{W}_{U}^{( i )} {H}^{( i )} {W}_{V}^{( i )}}}_{\approx I} {S}^{( i )} + {W}_{U}^{( i )} {H}^{( i )} {\sum }_{j , j \neq i} {W}_{V}^{( j )} {S}^{( j )} ,$$

where the second term represents the spatial multiplexing interference seen by UE(i). The goal for the network node is to construct the set of precoders

$$\{ {W}_{V}^{( j )} \}$$

such that the norm

$$‖ {H}^{( i )} {W}_{V}^{( i )} ‖$$

is large whereas the norm

$$‖ {H}^{( j )} {W}_{V}^{( i )} ‖ , j \neq i$$

is small. In other words, the precoder

$${W}_{V}^{( i )}$$

correlates well with the channel H⁽ⁱ⁾ observed by UE(i) whereas it correlates poorly with other channels.

To construct precoders for efficient MU-MIMO transmissions, the network node needs to acquire detailed knowledge of the channels H(i). In deployments where channel reciprocity holds, channel knowledge can be acquired from sounding reference signals (SRS) that are transmitted periodically, or on demand, by active wireless devices. Based on these SRS, the network node estimates H⁽ⁱ⁾ However, when channel reciprocity does not hold or when SRS coverage is limited, active wireless devices need to feedback channel details to the network node. In NR (as well as in LTE), this is performed by having the network node periodically transmit Channel State Information reference signals (CSI-RS) from which a wireless device can estimate its channel. The wireless device then reports CSI from which the network node can determine suitable precoders for MU-MIMO.

The CSI feedback mechanism targeting MU-MIMO operations in NR is referred to as CSI type II, in which a wireless device reports CSI feedback with high CSI resolution. It is based on specifying sets of DFT base functions (grid of beams) from which the wireless device selects those that best match its channel conditions (like classical codebook PMI). The number of beams the wireless device reports is configurable via RRC signaling, and may be 2 or 4 for Rel-15 Type II or 2, 4 or 6 for Rel-16 Type II. In Rel-16 Type II, the CSI report can be further compressed in the frequency domain (FD), where a set of FD DFT basis vectors are selected by the wireless device. The number of selected FD basis vectors is a function of the number of CQI subbands, the number of PMI subbands per CQI subband and a ratio that determines the FD compression (termed as pᵥ, where v is the layer index), which is configured by the network node via radio resource control (RRC) signaling. In addition, the wireless device also reports non-zero coefficients (NZCs) associated with the selected beams for Rel-15 Type II, which informs the network node how these beams should be combined in terms of relative amplitude scaling and co-phasing for each subband. In Rel-16, the reported NZCs are then associated with selected beams and FD basis vectors. In 3GPP Rel-16, to further compress the CSI report, the network node also configures a ratio, termed as β, to the wireless device via RRC signaling, that determines the maximum number of NZCs to be reported. For example, for a single layer transmission where 2L beams and M FD basis vectors are configured by network node, there are in total 2 LM linear combination coefficients. Then, only ┌2LMβ┐ NZCs will be reported at most, the remaining 2 LM−┌2LMβ┐ are treated as zeros and are not reported. The selected beams are commonly used for all subbands and all transmission layers, whereas the NZCs (for both Rel-15 and Rel-16 Type II) and FD basis vectors (for Rel-16 Type II) are layer-specific.

To further explain the structure of the Type II CSI, an example of the Rel-15 CSI type II is illustrated in the example of FIG. 2, which shows that the selection of discrete Fourier transform (DFT) beam vectors bₙ, and their relative amplitudes aₙ, are determined from a wideband perspective whereas the co-phasing is per subband. Here, wideband means that the selected DFT beam vectors are the same for all subcarriers used in the OFDM transmission, whereas subband means that co-phasing parameters are determined over subsets of contiguous subcarriers. The co-phasing parameters are quantized such that e^{jθ}^{ₙ} is taken from either a QPSK or 8PSK signal constellation.

With k denoting a sub-band index, the precoder reported by the wireless device can be expressed as

$${W}_{V} [ k ] = {\sum }_{n} {b}_{n} {a}_{n} {e}^{j {θ}_{n} [ k ]} .$$

Note that the reporting overhead for Type II CSI is generally large, especially when comparing to the Type I CSI. A dominant part of the reporting overhead is from subband reporting, e.g., the layer-specific NZCs. For instance, it requires about 7 bits (the actual number depends on the release version and parameter configuration) to report the phase and amplitude for one coefficient.

### CSI Reporting in NR

In NR, a wireless device can be configured with one or multiple CSI Report Settings, each configured by a higher layer parameter CSI-ReportConfig. Each CSI-ReportConfig is associated with a BWP and contains one or more of the following:
a CSI resource configuration for channel measurement
a CSI-IM resource configuration for interference measurement
reporting configuration type, i.e., aperiodic CSI (on physical uplink shared channel (PUSCH)), periodic CSI (on physical uplink control channel (PUCCH)), or semi-persistent CSI on PUCCH or PUSCH
report quantity specifying what to be reported, such as rank indicator RI, precoding matrix indicator (PMI), channel quality indicator (CQI)
codebook configuration such as type I or type II CSI
frequency domain configuration, i.e., subband vs. wideband CQI or PMI, and subband size
CQI table to be used

A wireless device can be configured with one or multiple CSI resource configurations for channel measurement and one or more CSI-IM resources for interference measurement. Each CSI resource configuration for channel measurement can contain one or more NZP CSI-RS resource sets. For each NZP CSI-RS resource set, it can further contain one or more NZP CSI-RS resources. A NZP CSI-RS resource can be periodic, semi-persistent, or aperiodic.

Similarly, each CSI-IM resource configuration for interference measurement can contain one or more CSI-IM resource sets. For each CSI-IM resource set, it can further contain one or more CSI-IM resources. A CSI-IM resource can be periodic, semi-persistent, or aperiodic.

### Type II CSI Report on PUSCH

A wireless device performs aperiodic CSI reporting using PUSCH upon successful decoding of a DCI format 0_1 or DCI format 0_2 which triggers an aperiodic CSI trigger state.

When a DCI format 0_1 schedules two PUSCH allocations, the aperiodic CSI report is carried on the second scheduled PUSCH. When a DCI format 0_1 schedules more than two PUSCH allocations, the aperiodic CSI report is carried on the penultimate scheduled PUSCH.

A wireless device performs semi-persistent CSI reporting on the PUSCH upon successful decoding of a downlink control information (DCI) format 0_1 or DCI format 0_2 which activates a semi-persistent CSI trigger state. DCI format 0_1 and DCI format 0_2 contains a CSI request field which indicates the semi-persistent CSI trigger state to activate or deactivate. The PUSCH resources and MCS are allocated semi-persistently by an uplink DCI.

CSI reporting on PUSCH can be multiplexed with uplink data on PUSCH. CSI reporting on PUSCH can also be performed without any multiplexing with uplink data from the wireless device.

### Part 1 and Part 2 for Type II CSI Report

For the 3GPP Rel-15 Type II and the 3GPP Rel-16 Type II (i.e., Enhanced Type II, or eType II) CSI feedback on PUSCH, a CSI report comprises of two parts: Part 1 and Part 2. A motivation for dividing a CSI report into Part 1 and Part 2 is to deal with the dynamically varying CSI payload. For example, based on the time-varying channel, the wireless device may report different ranks over the whole period of connection, which has significant impact on the actual required CSI payload size. In order for the network node to know the actual payload size, Part 1, which has a fixed payload size that carries the information to calculate the payload size of Part 2, will be decoded first by the network node.
For the 3GPP Rel-15 Type II CSI feedback, Part 1 contains RI (if reported), CQI, and an indication of the number of non-zero wideband amplitude coefficients per layer for the Type II CSI (see, for example, Clause 5.2.2.2.3 in 3GPP technical specification (TS) 38.214). The fields of Part 1—RI (if reported), CQI, and the indication of the number of non-zero wideband amplitude coefficients for each layer—are separately encoded. Part 2 contains the PMI of the Type II CSI. Part 1 and 2 are separately encoded.
For the 3GPP Rel-16 Type II CSI feedback, Part 1 contains RI, CQI, and an indication of the overall number of non-zero amplitude coefficients across layers for the 3GPP Rel-16 Type II CSI (see, for example, Clause 5.2.2.2.5 in 3GPP TS 38.214). The fields of Part 1—RI, CQI, and the indication of the overall number of non-zero amplitude coefficients across layers—are separately encoded. Part 2 contains the PMI of the Enhanced Type II CSI. Part 1 and 2 are separately encoded.

### CQI Conditioning for Type II CSI Report

Channel Quality Indicator (CQI) is reported together with a CSI report to inform the network node about the channel quality and what the wireless device expects to be able to receive, assuming that the network node does a transmission with the reported precoding matrix indicator (PMI). The CQI indicates the highest modulation scheme and coding rate (MCS) the wireless device believes it can receive reliably. The behavior is determined, in part, based on the below description of 3GPP specification, e.g., 3GPP TS 38.214.

### 5.2.1.4 Reporting Configurations

The UE shall calculate CSI parameters (if reported) assuming the following dependencies between CSI parameters (if reported)
LI shall be calculated conditioned on the reported CQI, PMI, RI and CRI
CQI shall be calculated conditioned on the reported PMI, RI and CRI
PMI shall be calculated conditioned on the reported RI and CRI.
RI shall be calculated conditioned on the reported CRI

### 5.2.2.1 Channel Quality Indicator (CQI)

Based on an unrestricted observation interval in time unless specified otherwise in 5.2.2.1, and an unrestricted observation interval in frequency, the UE shall derive for each CQI value reported in uplink slot n the highest CQI index which satisfies the following condition:
A single PDSCH transport block with a combination of modulation scheme, target code rate and transport block size corresponding to the CQI index, and occupying a group of downlink physical resource blocks termed the CSI reference resource, could be received with a transport block error probability not exceeding:
   0.1, if the higher layer parameter cqi-Table in CSI-ReportConfig configures ‘table1’ (corresponding to Table 5.2.2.1-2), or ‘table2’ (corresponding to Table 5.2.2.1-3), or
   0.00001, if the higher layer parameter cqi-Table in CSI-ReportConfig configures ‘table3’ (corresponding to Table 5.2.2.1-4).

### 5.2.2.5 CSI Reference Resource Definition

The CSI reference resource for a serving cell is defined as follows:
In the frequency domain, the CSI reference resource is defined by the group of downlink physical resource blocks corresponding to the band to which the derived CSI relates.
In the time domain, the CSI reference resource for a CSI reporting in uplink slot n′ is defined by a single downlink slot n−n_{CSI}_{_{ref}},
[ . . . ]
where for aperiodic CSI reporting, if the UE is indicated by the DCI to report CSI in the same slot as the CSI request, n_{CSI}_{_{ref}} is such that the reference resource is in the same valid downlink slot as the corresponding CSI request, otherwise n_{CSI}_{_{ref}} is the smallest value greater than or equal

$$⌊ \frac{{Z}^{′}}{{N}_{symb}^{slot}} ⌋ ,$$

such that slot n−n_{CSI}_{_{ref}} corresponds to a valid downlink slot, where Z′ corresponds to the delay requirement as defined in Clause 5.4.
[ . . . ]

If configured to report CQI index, in the CSI reference resource, the UE assumes the following for the purpose of deriving the CQI index, and if also configured, for deriving PMI and RI:
The first 2 OFDM symbols are occupied by control signaling.
[ . . . ]
Assume PRB bundling size of 2 PRBs.
The PDSCH transmission scheme where the UE may assume that PDSCH transmission would be performed with up to 8 transmission layers as defined in Clause 7.3.1.4 of 3GPP TS 38.211. For CQI calculation, the UE should assume that PDSCH signals on antenna ports in the set [1000, . . . , 1000+v−1] for v layers would result in signals equivalent to corresponding symbols transmitted on antenna ports [3000, . . . , 3000+P−1], as given by

$$[ \begin{matrix}{y}^{( 3000 )} ( i ) \\ … \\ {y}^{( 300 \; 0 + P - 1 )} ( i )\end{matrix} ] = W ( i ) [ \begin{matrix}{x}^{( 0 )} ( i ) \\ … \\ {x}^{( v - 1 )} ( i )\end{matrix} ]$$

where x(i)=[x⁽⁰⁾(i) . . . x^{(v-1)}(i)] T is a vector of PDSCH symbols from the layer mapping defined in Clause 7.3.1.4 of 3GPP TS 38.211, P∈[1, 2, 4, 8, 12, 16, 24, 32] is the number of CSI-RS ports. If only one CSI-RS port is configured, W (i) is 1. If the higher layer parameter reportQuantity in CSI-ReportConfig for which the CQI is reported is set to either ‘cri-RI-PMI-CQI’ or ‘cri-RI-LI-PMI-CQI’, W (i) is the precoding matrix corresponding to the reported PMI applicable to x(i). If the higher layer parameter reportQuantity in CSI-ReportConfig for which the CQI is reported is set to ‘cri-RI-CQI’, W (i) is the precoding matrix corresponding to the procedure described in Clause 5.2.1.4.2. If the higher layer parameter reportQuantity in CSI-ReportConfig for which the CQI is reported is set to ‘cri-RI-i1-CQI’, W (i) is the precoding matrix corresponding to the reported i1 according to the procedure described in Clause 5.2.1.4.2. The corresponding PDSCH signals transmitted on antenna ports [3000, . . . , 3000+P−1] would have a ratio of EPRE to CSI-RS EPRE equal to the ratio given in Clause 5.2.2.3.1

### Autoencoders for AI/ML-Enhanced CSI Reporting

Neural network based autoencoders (AEs) have shown promising results for compressing downlink MIMO channel estimates for uplink feedback.

Furthermore, 3GPP decided to start a study item for Rel. 18 that includes the use case of AI-based CSI reporting in which AEs will play a central part of the study. Specifically, an AE is a type of artificial neural network (NN) that can be used to compress and decompress data, in an unsupervised manner, often with high fidelity. FIG. 3 illustrates a low complexity-fully connected (dense) AE. The AE is divided into two parts:
an encoder (used to compress the input data X), and
a decoder (used to de-compress the input data).

AEs can have different architectures. For example, AEs can be based on dense NNs, multi-dimensional convolution NNs, variational, recurrent NNs, transformer networks, or any combination thereof. However, all AE architectures possess an encoder-bottleneck-decoder structure illustrated in FIG. 3.

The size of the codeword (denoted by Y in FIG. 3) of an AE is typically a lot smaller than the size of the input data (X in FIG. 3). The AE encoder thus reduces the dimensionality of the input features X down to Y. The decoder part of the AE tries to invert the encoder and reconstruct X with minimal error, according to some predefined loss function.

FIG. 4 illustrates how an AE might be used for AI/ML-enhanced CSI reporting in NR. The wireless device measures the channel in the downlink using CSI-RS. The wireless device estimates that channel for each subcarrier (SC) from each base station TX antenna and at each wireless device RX antenna. The estimate can be viewed as a three-dimensional channel matrix. The 3D channel matrix represents the MIMO channel estimated over several SCs and is input to the encoder.

The AE encoder is implemented in the wireless device, and the AE decoder is implemented in the network node or network (NW). The output of the AE encoder is signalled from the wireless device to the network node and/or NW over the uplink. The codeword can be considered as learned latent representation of the channel. The architecture of an AE (e.g., number of layers, nodes per layer, activation function, etc.) typically needs to be numerically optimized for CSI reporting via a process called hyperparameter tuning. Properties of the data (e.g., CSI-RS channel estimates), the channel size, uplink feedback rate, and hardware limitations of the encoder and decoder all need to be considered when optimizing the AE's architecture.

The weights and biases of an AE (with a fixed architecture) are trained to minimize the reconstruction error (the error between the input X and output X) on some training dataset. For example, the weights and biases can be trained to minimize the mean squared error (MSE) [symbol] . Model training is typically done using some variant of the gradient descent algorithm on a large training data set. To achieve good performance during live operation, the training data set should be representative of the actual data the AE will encounter during live operation.

In the two-sided CSI compression, the output of the wireless device-side encoder needs to be communicated over the air interface to the network node decoder with the assigned CSI reporting payload and, therefore, needs to be quantized to a finite number of bits (e.g., 1-4 bits per sample for the UCI) to obtain an efficient transmission as shown in FIG. 5. Accordingly, a quantization layer is usually connected at the output of the encoder or directly included in the encoder. In an example, the quantization layer may implement scalar quantization which quantizes the output of each neuron of the encoder output layer (the bottleneck layer of AE) to generate bits to fit the CSI reporting payload in the UCI. Other quantization methods, e.g., vector quantization, may also be used.

### Pre-Processing for Input Data to the AE

A pre-processing process on the input to the encoder can greatly reduce the size and complexity for designing and/or training an AI/ML model, and in the meantime, improving the scalability and transferability of the model. In the CSI compression, a pre-processing method could be a transformation of the channel from antenna-frequency domain to beam-delay domain, or from the antenna-frequency-time domain to the beam-delay-doppler domain. In addition, the pre-processing is used to reduce the need for multiple models depending on bandwidth variation and variation in the number of antenna ports at the network node.

For example, the channel representation in the antenna-frequency domain is usually rich and hard to compress, however, its equivalent form in the beam-delay domain is sparse and easier to compress. Such sparsity, to some extent, reflects the physical interpretation of a propagation channel. That is, it reflects how the numerous sinusoidal signals traverse from the transmitting end, along different paths, to the receiving end. Each beam can be associated with a certain direction of a propagation path, and each delay can reflect the relative difference in distance if a signal propagates along different paths. Ideally, one can think of each pair of beam and delay is associated with a single propagation path, if there is infinite spatial resolution and delay resolution.

In a real propagation environment, dominant paths that contribute to conveying a signal are usually sparse if when the whole 3D space is considered, since the signal cannot reach to the receiver end from any direction. Among other reasons, this may be limited by the antenna directivity and the number of antenna elements deployed at both the transmitter and the receiver, as well as the number of objects in the propagation environment that can reflect a signal without introducing significant loss. The above sparsity can be exploited to assist an AI/ML model. For example, the beam-delay domain transformation could help the AI/ML model with an initial feature extraction. Another advantage of this pre-processing is that the beam-delay transformation can be achieved using FFTs, for which there are already fast implementations with hardware support. The sparsity can be further exploited by removing a number of insignificant beams and delays, so that the input dimensions could also be reduced with a marginal loss, likely resulting in smaller AI/ML models. The beam-delay transformation and feature extraction can be applied both cases of explicit channel feedback and eigenvector-based feedback.

An example is described next for pre-processing of the eigenvector-based feedback, which has received attention in 3GPP. The first step is that the wireless device measures the channel on CSI-RS. For example, let the wireless device have 4 Rx-ports, the configured CSI-format has 32 virtual Tx-ports, and the bandwidth are 52 RBs corresponding to 10 MHz at 15 kHz subcarrier spacing. The feature extraction for eigenvector-based feedback is illustrated in the example of FIG. 6. The steps are as follows:
1 The wireless device does a spatial domain DFT on the 32×4 matrix per RB and selects the L strongest beams out of 16 (for one polarization). This is performed in a wideband manner, including the spatial oversampling of the spatial-domain (SD) basis, and the same beams are used for both polarizations. The covariance of the beam-space channel is summed over, e.g., 4 RBs to produce a covariance matrix for each subband.
2. For each covariance matrix (per subband) the wireless device extracts a number of eigenvectors and may select the rank, i.e., number of layers.
3. The wireless device does a frequency domain DFT per layer, transforming to delay domain, whereafter it selects the M strongest taps. The resulting tensor of dimensions 2L×number of layers×M is called the linear combination coefficients and can be used to reconstruct, by the wireless device suggested, precoding matrices.
4. The tensor of linear combination coefficients is used as input in the AI/ML model. The input could be further enhanced with information about the selected beams and taps, noise levels, etc.

### Configuration of AI/ML-Enhanced CSI Reporting

In some systems, AI/ML based CSI reporting can be configured using RRC. Specifically, this is achieved by setting the reportQuantity in the CSI-reportConfig IE to a new value ‘cri-RI-aiPMI-CQI’.

### Target CSI (T-CSI)

Target CSI (T-CSI) has been discussed in the RAN1 #111 meeting. The discussion has been focused on:
perform training, compare results in intermediate KPIs, and perform model monitoring;
as well as how to perform training and the use as nominal input to encoders, CQI calculation, and perform model monitoring.

The target CSI (T-CSI) may be understood as a high-resolution CSI report. It has been suggested to standardized the format for target CSI, as well as the necessity to collect such target CSI for both training purposes as well as for model monitoring and LCM.

In legacy CSI reporting when PMI reporting is configured, the CQI is calculated based on hypothesis that the transmitter will use a certain multi-antenna precoding matrix, which is the precoding matrix selected from a standardized codebook that the wireless device feed back to the network or network node in a reported PMI (e.g., a precoding matrix or a wideband beam index). The reported PMI and thus the assumed transmission hypothesis is known to both the wireless device and the network node.

In AI-CSI reporting, there is no codebook agreed upon or used between the transmitter and the receiver. Hence, the wireless device cannot make an assumption (and report the assumption) of the transmission hypothesis for the multi-antennas when computing the CQI, as in the legacy case. Therefore, it is undefined how to compute CQI for AI-CSI without a codebook of precoding matrices to refer to.

### SUMMARY

Some embodiments advantageously provide methods, systems, and apparatuses for ML-based CSI report.

In one or more embodiments, methods for calculating CQI for AI-based CSI reporting are described. In addition, methods for network configuration that facilitates CQI calculating are also described.

According to one aspect of the present disclosure, a method implemented by a wireless device is provided. The wireless device is configured to communicate with a network node. Channel measurements are performed. A channel state information, CSI, report is generated based on the channel measurements, where the CSI report includes a channel quality indicator, CQI, that is based on a target CSI.

According to one or more embodiments of this aspect, the target CSI is a common reference for the wireless device to calculate the CQI and for the network node to interpret the CQI in non-codebook based CSI.

According to one or more embodiments of this aspect, a hypothetical precoder is calculated based on the target CSI, where the CQI is calculated based on the hypothetical precoder.

According to one or more embodiments of this aspect, the CSI report is based on a transmission hypothesis associated with at least one hypothetical transmission parameters, where the CQI is an expected CQI for communications using the at least one hypothetical transmission.

According to one or more embodiments of this aspect, at least one parameter for calculating the CQI is received, where the at least one parameter comprises at least one of a CSI-reference signal, CSI-RS, resource, rank or CSI-RS port.

According to one or more embodiments of this aspect, the target CSI is reported to the network node.

According to one or more embodiments of this aspect, the target CSI is reported to the network node during a model training phase or monitoring phase.

According to one or more embodiments of this aspect, the target CSI is a channel tensor in a predefined domain.

According to one or more embodiments of this aspect, the predefined domain is one of: an antenna-frequency domain, beam-delay domain, or beam-delay-doppler domain.

According to one or more embodiments of this aspect, the target CSI is one of a calculated hypothetical precoder or a plurality of eigenvectors of the channel measurements.

According to one or more embodiments of this aspect, the target CSI is unreported to the network node by the wireless device.

According to one or more embodiments of this aspect, a CQI offset corresponding to a CQI mismatch between the wireless device and network node is determined, and the CQI offset is reported to the network node.

According to one or more embodiments of this aspect, the CSI report is a machine learning, ML, based CSI report.

According to another aspect of the present disclosure, a wireless device that is configured to communicate with a network node is provided. The wireless device is configured to: perform channel measurements, and generate a channel state information, CSI, report based on the channel measurements, where the CSI report includes a channel quality indicator, CQI, that is based on a target CSI.

According to one or more embodiments of this aspect, the target CSI is a common reference for the wireless device to calculate the CQI and for the network node to interpret the CQI in non-codebook based CSI.

According to one or more embodiments of this aspect, the wireless device is further configured to calculate a hypothetical precoder based on the target CSI, where the CQI is calculated based on the hypothetical precoder.

According to one or more embodiments of this aspect, the CSI report is based on a transmission hypothesis associated with at least one hypothetical transmission parameters, where the CQI is an expected CQI for communications using the at least one hypothetical transmission.

According to one or more embodiments of this aspect, the wireless device is further configured to receive at least one parameter for calculating the CQI, where the at least one parameter comprises at least one of a CSI-reference signal, CSI-RS, resource, rank or CSI-RS port.

According to one or more embodiments of this aspect, the wireless device is further configured to report the target CSI to the network node.

According to one or more embodiments of this aspect, the target CSI is reported to the network node during a model training phase or monitoring phase.

According to one or more embodiments of this aspect, the target CSI is a channel tensor in a predefined domain.

According to one or more embodiments of this aspect, the predefined domain is one of: an antenna-frequency domain, beam-delay domain, or beam-delay-doppler domain.

According to one or more embodiments of this aspect, the target CSI is one of a calculated hypothetical precoder or a plurality of eigenvectors of the channel measurements.

According to one or more embodiments of this aspect, the target CSI is unreported to the network node by the wireless device.

According to one or more embodiments of this aspect, the wireless device is further configured to: determine a CQI offset corresponding to a CQI mismatch between the wireless device and network node, and report the CQI offset to the network node.

According to one or more embodiments of this aspect, the CSI report is a machine learning, ML, based CSI report.

According to another aspect of the present disclosure, a method implemented by a network node is provided. The network node is configured to communicate with a wireless device. A channel state information, CSI, report is received where the CSI report comprises a channel quality indicator, CQI, that is based on a target CSI. Autoencoder-based decoding is performed based on the CSI report and CQI for deriving a precoder for transmission to the wireless device (22).

According to one or more embodiments of this aspect, the target CSI is a common reference for the wireless device to calculate the CQI and for the network node to interpret the CQI for non-codebook based CSI.

According to one or more embodiments of this aspect, the CQI is based on a hypothetical precoder, the hypothetical precoder being based on the target CSI.

According to one or more embodiments of this aspect, the CSI report is based on a transmission hypothesis associated with at least one hypothetical transmission parameters, where the CQI is an expected CQI for communications using the at least one hypothetical transmission.

According to one or more embodiments of this aspect, at least one parameter is transmitted to the wireless device for calculating the CQI, where the at least one parameter comprises at least one of a CSI-reference signal, CSI-RS, resource, rank or CSI-RS port.

According to one or more embodiments of this aspect, signaling indicating the target CSI is received from the wireless device.

According to one or more embodiments of this aspect, the target CSI is received during a model training phase or monitoring phase.

According to one or more embodiments of this aspect, the target CSI is a channel tensor in a predefined domain.

According to one or more embodiments of this aspect, the predefined domain is one of: an antenna-frequency domain, beam-delay domain, or beam-delay-doppler domain.

According to one or more embodiments of this aspect, the target CSI is one of a calculated hypothetical precoder or a plurality of eigenvectors of channel measurements.

According to one or more embodiments of this aspect, the target CSI is unreported to the network node by the wireless device.

According to one or more embodiments of this aspect, the performing autoencoder-based decoding is further based on a CQI offset, where the CQI offset corresponds to a CQI mismatch between the wireless device and network node, and the CQI offset is one of: received, at the network node, from the wireless device; or determined by the network node.

According to one or more embodiments of this aspect, the CSI report is a machine learning, ML, based CSI report.

According to another aspect of the present disclosure, a network node is configured to communicate with a wireless device. The network node configured to: receive a channel state information, CSI, report, where the CSI report comprises a channel quality indicator, CQI, that is based on a target CSI, and perform autoencoder-based decoding based on the CSI report and CQI for deriving a precoder for transmission to the wireless device.

According to one or more embodiments of this aspect, the target CSI is a common reference for the wireless device to calculate the CQI and for the network node to interpret the CQI for non-codebook based CSI.

According to one or more embodiments of this aspect, the CQI is based on a hypothetical precoder, the hypothetical precoder being based on the target CSI.

According to one or more embodiments of this aspect, the CSI report is based on a transmission hypothesis associated with at least one hypothetical transmission parameters, the CQI being an expected CQI for communications using the at least one hypothetical transmission.

According to one or more embodiments of this aspect, the network node is further configured to transmit at least one parameter to the wireless device for calculating the CQI, the at least one parameter comprises at least one of a CSI-reference signal, CSI-RS, resource, rank or CSI-RS port.

According to one or more embodiments of this aspect, the network node is further configured to receive, from the wireless device, signaling indicating the target CSI.

According to one or more embodiments of this aspect, the network node is further configured to receive the target CSI during a model training phase or monitoring phase.

According to one or more embodiments of this aspect, the target CSI is a channel tensor in a predefined domain.

According to one or more embodiments of this aspect, the predefined domain is one of: an antenna-frequency domain, beam-delay domain, or beam-delay-doppler domain.

According to one or more embodiments of this aspect, the target CSI is one of a calculated hypothetical precoder or a plurality of eigenvectors of channel measurements.

According to one or more embodiments of this aspect, the target CSI is unreported to the network node by the wireless device.

According to one or more embodiments of this aspect, the performing autoencoder-based decoding is further based on a CQI offset, where the CQI offset corresponds to a CQI mismatch between the wireless device and network node, and the CQI offset is one of: received, at the network node, from the wireless device, or determined by the network node.

According to one or more embodiments of this aspect, the CSI report is a machine learning, ML, based CSI report.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a MU-MIMO operation;

FIG. 2 is a diagram of CSI type II feedback;

FIG. 3 is a diagram of a fully connected autoencoder;

FIG. 4 is a diagram of an autoencoder for CSI compression;

FIG. 5 is a diagram of a quantization operation at the output of the encoder to fit the CSI payload over the air interface;

FIG. 6 is a diagram of pre-processing for implicit feedback of the eigenvector depending on the estimated transmission rank;

FIG. 7 is a schematic diagram of an example network architecture illustrating a communication system connected via an intermediate network to a host computer according to the principles in the present disclosure;

FIG. 8 is a block diagram of a host computer communicating via a network node with a wireless device over an at least partially wireless connection according to some embodiments of the present disclosure;

FIG. 9 is a flowchart illustrating example methods implemented in a communication system including a host computer, a network node and a wireless device for executing a client application at a wireless device according to some embodiments of the present disclosure;

FIG. 10 is a flowchart illustrating example methods implemented in a communication system including a host computer, a network node and a wireless device for receiving user data at a wireless device according to some embodiments of the present disclosure;

FIG. 11 is a flowchart illustrating example methods implemented in a communication system including a host computer, a network node and a wireless device for receiving user data from the wireless device at a host computer according to some embodiments of the present disclosure;

FIG. 12 is a flowchart illustrating example methods implemented in a communication system including a host computer, a network node and a wireless device for receiving user data at a host computer according to some embodiments of the present disclosure;

FIG. 13 is a flowchart of an example process in a network node according to some embodiments of the present disclosure;

FIG. 14 is a flowchart of another example process in a network node according to some embodiments of the present disclosure;

FIG. 15 is a flowchart of an example process in a wireless device according to some embodiments of the present disclosure;

FIG. 16 is a flowchart of another example process in a wireless device according to some embodiments of the present disclosure; and

FIG. 17 is a diagram of an example architecture of the channel eigenvector feedback approach for CSI report in the UCI to generate the precoders for each transmitted layer.

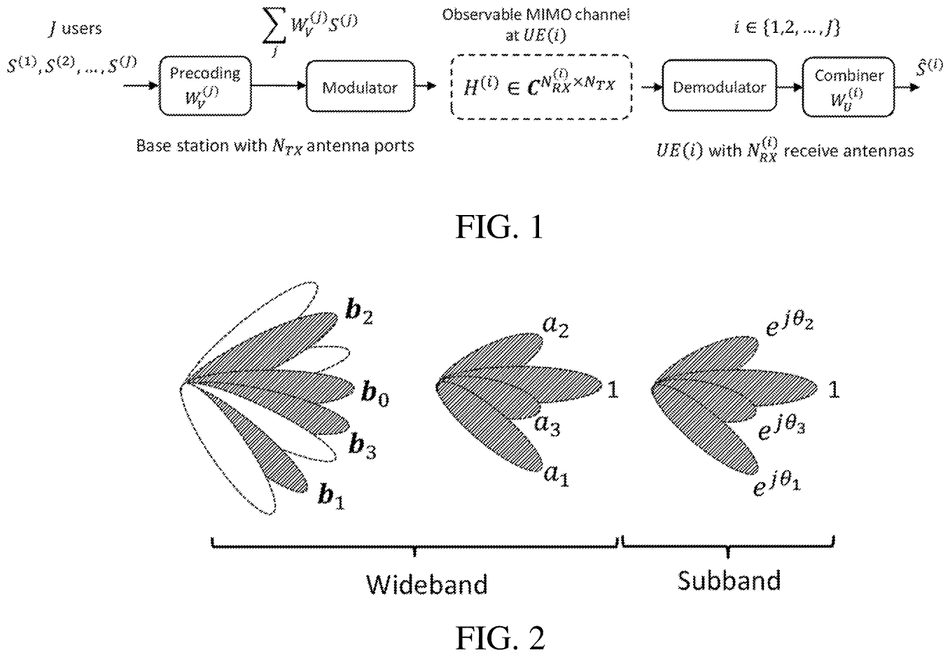

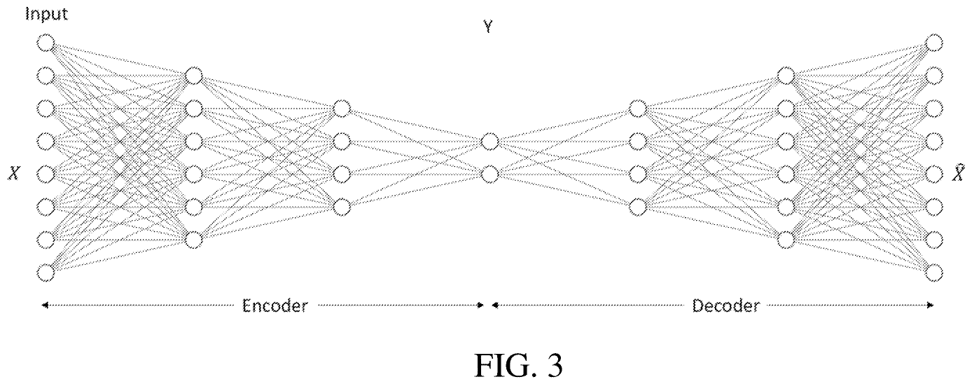

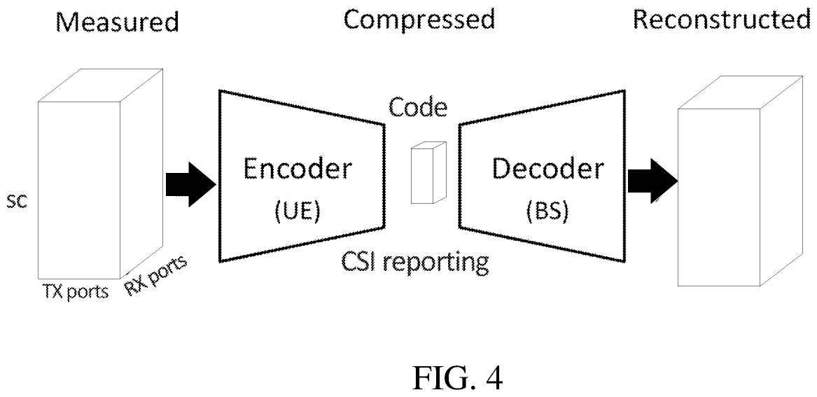

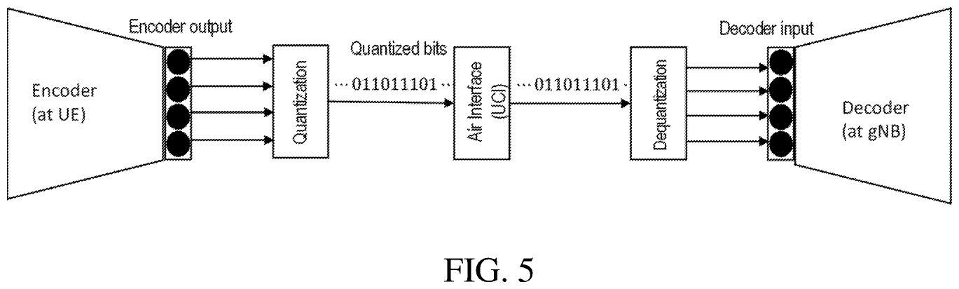

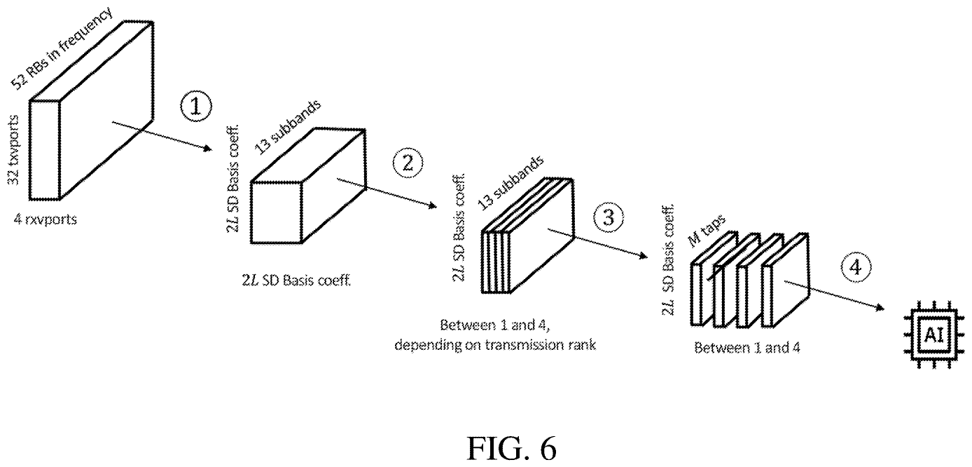

### DETAILED DESCRIPTION

As discussed above, in AI-CSI reporting, there is no codebook agreed upon or used between the transmitter and the receiver. Hence, the wireless device cannot make an assumption (and report the assumption) of the transmission hypothesis for the multi-antennas when computing the CQI, as in the legacy case. It is thus unknown how to compute a CQI for AI-CSI without a codebook of precoding matrices to refer to when it comes to the transmission hypothesis assumed for the CQI.

Before describing in detail example embodiments, it is noted that the embodiments reside primarily in combinations of apparatus components and processing steps related to ML-based CSI report. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), a device handling D2D communication, etc. The network node may also comprise test equipment. The term “radio node” used herein may be used to also denote a wireless device (WD) such as a wireless device (WD) or a radio network node.

Further, a network node may be configured to handle at least some machine learning (ML) operation(s). The node may be deployed in a 5G network, or a 6G network.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

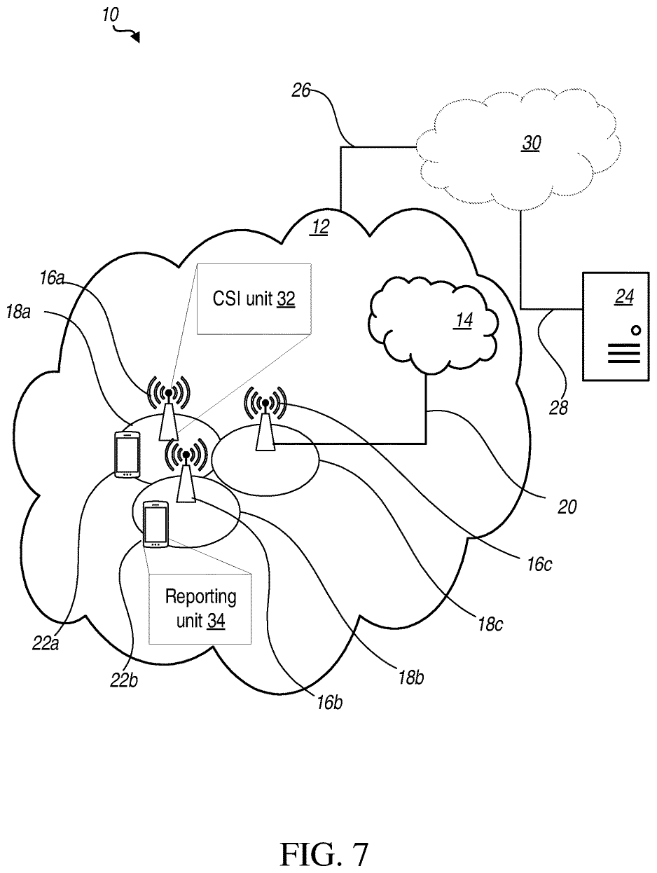

Some embodiments provide ML-based CSI reports. Referring again to the drawing figures, in which like elements are referred to by like reference numerals, there is shown in FIG. 7 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 7 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a CSI unit 32 which is configured to perform one or more network node 16 functions described herein such as, for example, with respect to ML-based CSI report. A wireless device 22 is configured to include a reporting unit 34 which is configured to perform one or more wireless device 22 functions as described herein such as, for example, with respect to ML-based CSI report.

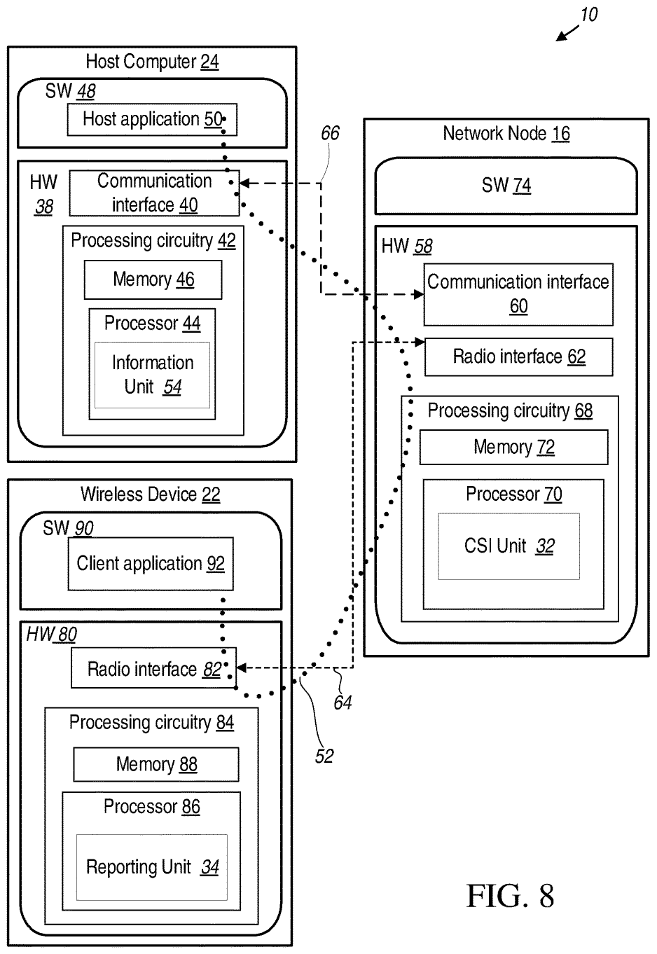

Example implementations, in accordance with an embodiment, of the WD 22, network node 16 and host computer 24 discussed in the preceding paragraphs will now be described with reference to FIG. 8. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of analyze, determine, process, store, forward, transmit, receive, communicate, etc. information related to ML-based CSI report.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include CSI unit 32 configured to perform one or more network node 16 functions as described herein such as, for example, functions related to an ML-based CSI report.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a reporting unit 34 configured to perform one or more wireless device 22 functions as described herein such as, for example, with respect to an ML-based CSI report.

In some embodiments, the inner workings of the network node 16, WD 22, and host computer 24 may be as shown in FIG. 8 and independently, the surrounding network topology may be that of FIG. 7.

In FIG. 8, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 7 and 8 show various “units” such as CSI unit 32, and reporting unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

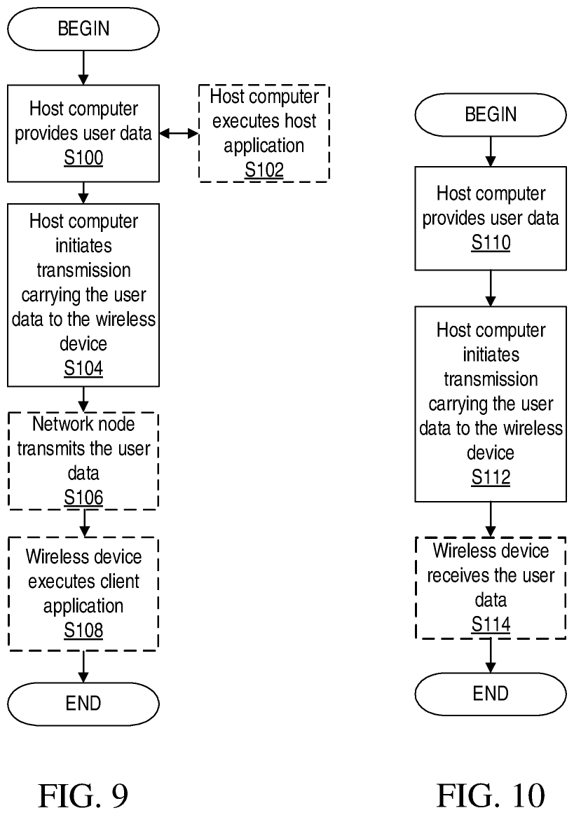

FIG. 9 is a flowchart illustrating an example method implemented in a communication system, such as, for example, the communication system of FIGS. 7 and 8, in accordance with one embodiment. The communication system may include a host computer 24, a network node 16 and a WD 22, which may be those described with reference to FIG. 8. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 10 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

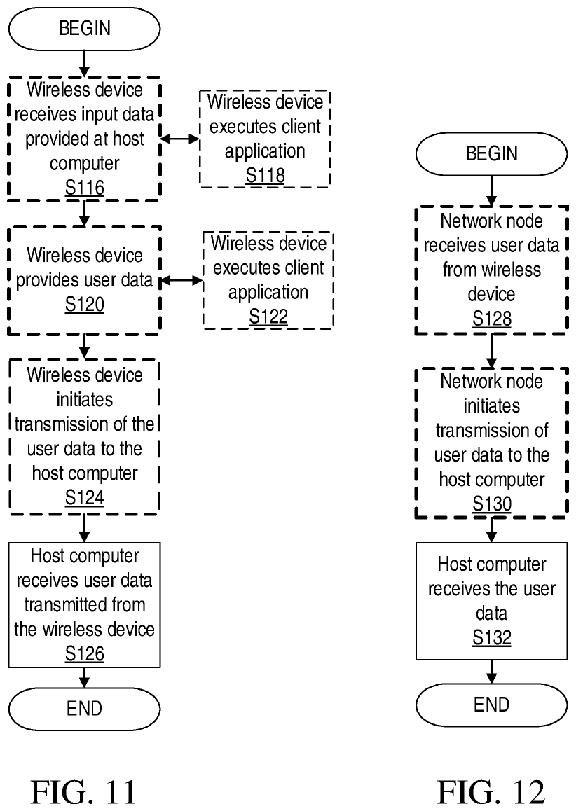

FIG. 11 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 12 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

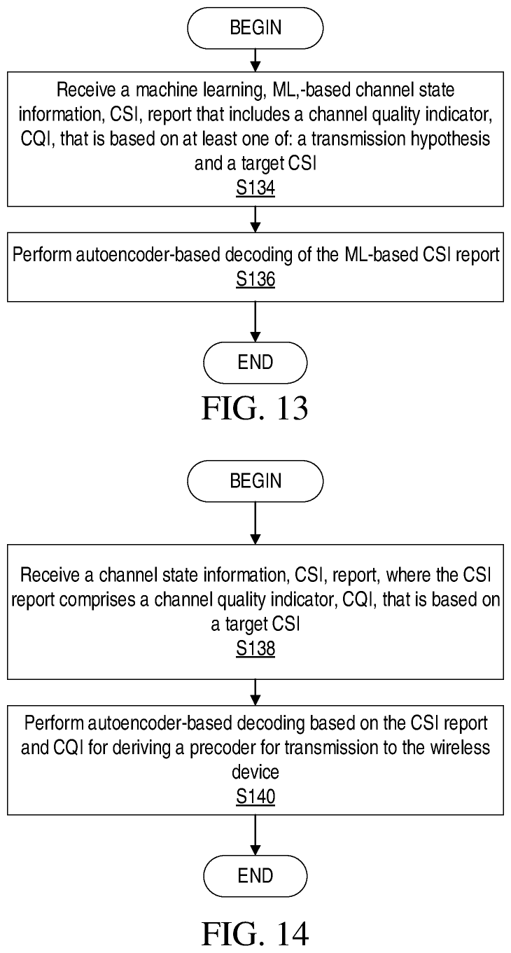

FIG. 13 is a flowchart of an example process in a network node 16 according to some embodiment of the present disclosure. One or more blocks described herein may be performed by one or more elements of network node 16 such as by one or more of processing circuitry 68 (including the CSI unit 32), processor 70, radio interface 62 and/or communication interface 60. Network node 16 is configured to receive (Block S134) a machine learning, ML-based channel state information, CSI, report that includes a channel quality indicator, CQI, that is based on at least one of: a transmission hypothesis and a target CSI, as described herein. Network node 16 is configured to perform (Block S136) autoencoder-based decoding of the ML-based CSI report, as described herein.

According to one or more embodiments, the CQI is based on a hypothetical precoder that is calculated based on the target CSI.

According to one or more embodiments, the processing circuitry 68 is further configured to configure parameters for generating a hypothesis CSI.

According to one or more embodiments, the transmission hypothesis corresponds to an entry in an intermediate precoding matrix codebook.

According to one or more embodiments, the transmission hypothesis is one of a hypothesis CSI and hypothesis precoder matrix indicator, PMI.

According to one or more embodiments, the processing circuitry 68 is further configured to: receive a reporting of the target CSI, and train an ML model based on the target CSI, the ML model being associated with the CSI reporting.

According to one or more embodiments, the target CSI is a channel tensor in a predefined domain.

FIG. 14 is a flowchart of another example process in a network node 16 according to some embodiment of the present disclosure. One or more blocks described herein may be performed by one or more elements of network node 16 such as by one or more of processing circuitry 68 (including the CSI unit 32), processor 70, radio interface 62 and/or communication interface 60. Network node 16 is configured to receive (Block S138) a channel state information, CSI, report, the CSI report comprising a channel quality indicator, CQI, that is based on a target CSI, as described herein. The network node 16 is configured to perform (Block S140) autoencoder-based decoding based on the CSI report and CQI for deriving a precoder for transmission to the wireless device 22.

According to one or more embodiments, the target CSI is a common reference for the wireless device 22 to calculate the CQI and for the network node 16 to interpret the CQI for non-codebook based CSI.

According to one or more embodiments, the CQI is based on a hypothetical precoder, the hypothetical precoder being based on the target CSI.

According to one or more embodiments, the CSI report is based on a transmission hypothesis associated with at least one hypothetical transmission parameters, where the CQI is an expected CQI for communications using the at least one hypothetical transmission.

According to one or more embodiments, the network node 16 is further configured to transmit at least one parameter to the wireless device 22 for calculating the CQI, where the at least one parameter comprises at least one of a CSI-reference signal, CSI-RS, resource, rank or CSI-RS port.

According to one or more embodiments, the network node 16 is further configured to receive, from the wireless device 22, signaling indicating the target CSI.

According to one or more embodiments, the network node 16 is further configured to receive the target CSI during a model training phase or monitoring phase.

According to one or more embodiments, the target CSI is a channel tensor in a predefined domain.

According to one or more embodiments, the predefined domain is one of: an antenna-frequency domain, beam-delay domain, or beam-delay-doppler domain.

According to one or more embodiments, the target CSI is one of a calculated hypothetical precoder or a plurality of eigenvectors of channel measurements.

According to one or more embodiments, the target CSI is unreported to the network node 16 by the wireless device 22.

According to one or more embodiments, the performing autoencoder-based decoding is further based on a CQI offset, where the CQI offset corresponds to a CQI mismatch between the wireless device 22 and network node 16, and where the CQI offset being one of: received, at the network node 16, from the wireless device 22, or determined by the network node 16.

According to one or more embodiments, the CSI report is a machine learning, ML, based CSI report.

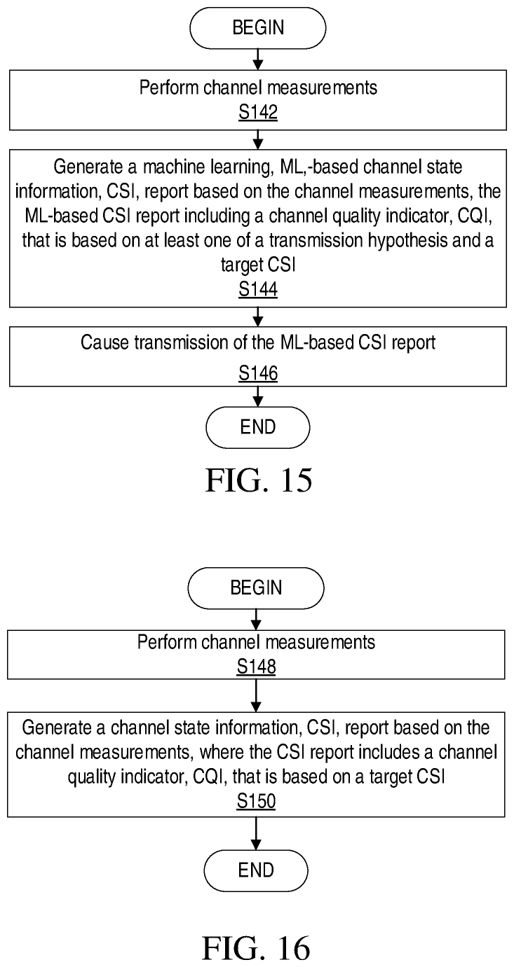

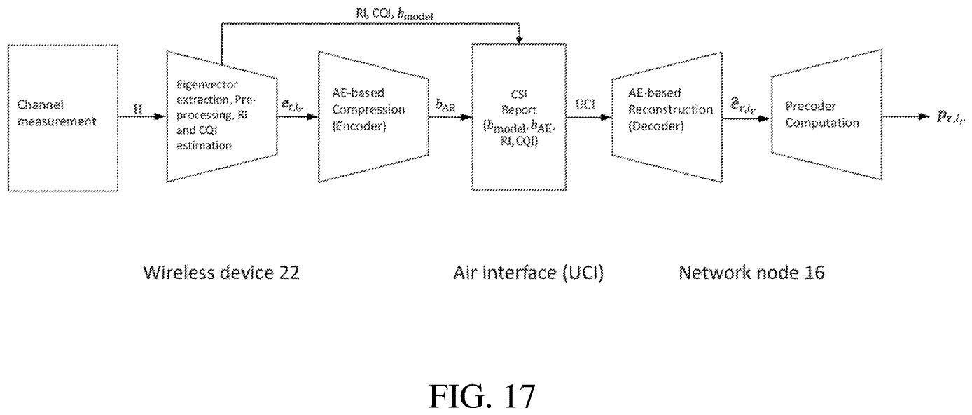

FIG. 15 is a flowchart of an example process in a wireless device 22 according to some embodiments of the present disclosure. One or more blocks described herein may be performed by one or more elements of wireless device 22 such as by one or more of processing circuitry 84 (including the reporting unit 34), processor 86, radio interface 82 and/or communication interface 60. Wireless device 22 is configured to perform (Block S142) channel measurements, as described herein. Wireless device 22 is configured to generate (Block S144) a machine learning, ML-based channel state information, CSI, report based on the channel measurements, the ML-based CSI report including a channel quality indicator, CQI, that is based on at least one of a transmission hypothesis and a target CSI, as described herein. Wireless device 22 is configured to cause (Block S146) transmission of the ML-based CSI report, as described herein.

According to one or more embodiments, the CQI is based on a hypothetical precoder that is calculated based on the target CSI.

According to one or more embodiments, the processing circuitry 84 is further configured to receive parameters for generating a hypothesis CSI.

According to one or more embodiments, the transmission hypothesis corresponds to an entry in an intermediate precoding matrix codebook.

According to one or more embodiments, the transmission hypothesis is one of a hypothesis CSI and hypothesis precoder matrix indicator, PMI.

According to one or more embodiments, the processing circuitry 84 is further configured to: report the target CSI for training an ML model associated with the CSI reporting.

According to one or more embodiments, the target CSI is a channel tensor in a predefined domain.

FIG. 16 is a flowchart of another example process in a wireless device 22 according to some embodiments of the present disclosure. One or more blocks described herein may be performed by one or more elements of wireless device 22 such as by one or more of processing circuitry 84 (including the reporting unit 34), processor 86, radio interface 82 and/or communication interface 60. Wireless device 22 is configured to perform (Block S148) channel measurements, as described herein. Wireless device 22 is configured to generate (Block S150) a channel state information, CSI, report based on the channel measurements, where the CSI report includes a channel quality indicator, CQI, that is based on a target CSI, as described herein.

According to one or more embodiments, the target CSI is a common reference for the wireless device 22 to calculate the CQI and for the network node 16 to interpret the CQI in non-codebook based CSI.

According to one or more embodiments, the wireless device 22 is further configured to calculate a hypothetical precoder based on the target CSI, where the CQI being calculated based on the hypothetical precoder.

According to one or more embodiments, the CSI report is based on a transmission hypothesis associated with at least one hypothetical transmission parameters, the CQI being an expected CQI for communications using the at least one hypothetical transmission.

According to one or more embodiments, the wireless device 22 is further configured to receive at least one parameter for calculating the CQI, the at least one parameter comprises at least one of a CSI-reference signal, CSI-RS, resource, rank or CSI-RS port.

According to one or more embodiments, the wireless device 22 is further configured to report the target CSI to the network node 16.

According to one or more embodiments, the target CSI is reported to the network node 16 during a model training phase or monitoring phase.

According to one or more embodiments, the target CSI is a channel tensor in a predefined domain.

According to one or more embodiments, the predefined domain is one of: an antenna-frequency domain, beam-delay domain; or beam-delay-doppler domain.

According to one or more embodiments, the target CSI is one of a calculated hypothetical precoder or a plurality of eigenvectors of the channel measurements.

According to one or more embodiments, the target CSI is unreported to the network node 16 by the wireless device 22.

According to one or more embodiments, the wireless device 22 is further configured to: determine a CQI offset corresponding to a CQI mismatch between the wireless device 22 and network node 16, and report the CQI offset to the network node 16.

According to one or more embodiments, the CSI report is a machine learning, ML, based CSI report.

Having described the general process flow of arrangements of the disclosure and having provided examples of hardware and software arrangements for implementing the processes and functions of the disclosure, the sections below provide details and examples of arrangements for an ML-based CSI report.

Some embodiments provide an ML-based CSI report. One or more network node 16 functions described below may be performed by one or more of processing circuitry 68, processor 70, CSI unit 32, radio interface 62, etc. One or more wireless device 22 functions described below may be performed by one or more of processing circuitry 84, processor 86, reporting unit 34, radio interface 82, etc.

The wireless device 22 estimates the DL channel based on the configured DL reference signals (e.g., CSI-RS, DMRS, etc.), and produces a channel estimate H, for example, in the antenna-frequency domain. The raw channel H can be expressed per CSI-RS port (TX side), per receive antenna (RX side), per frequency subband, and measured at one or more points in time. Hence, in some cases, the channel H is a four-dimensional matrix or tensor.

The raw channel estimate of the desired downlink channel from the network node 16 to the wireless device H (possibly together with a similar estimate of the interference channel, that is from another non-serving network node 16 to the wireless device 22) is leveraged to estimate the appropriate rank for the downlink transmission and further processed to extract the eigenvector corresponding to each layer according to the estimated rank r.

The eigenvectors per transmission layer based on r is denoted by e_{r,l}_{ᵣ}, where lᵣ=1, 2, . . . , r. For measurements with CSI-RS at a single time instance, er, is a tensor with dimension equal to number of CSI-RS ports×number of layers×number of frequency subbands. The extracted e_{r,l}_{ᵣ} are compressed and quantized at the encoder into bits, such that bₗ_{ᵣ} represents the bits for quantizing the lᵣ-th transmission layer. Subsequently, the concatenated bits across all the transmission layers, denoted by b_{AE}=[b₁, b₂, . . . , bₗ_{ᵣ}], along with the rank indication (RI) and channel quality indicator (CQI), is reported back to the network node as part of the uplink CSI report. The CSI report comprising of b_{AE} and the legacy parameters computed from the estimated channel H, i.e., RI and CQI, are fed to the decoder deployed at the network node 16 to reconstruct the eigenvectors per layer, denoted by ê_{r,l}_{ᵣ}, lᵣ=1, 2, . . . , r. The network node 16 can further process the eigenvectors to obtain the precoders for each layer, denoted by p_{r,l}_{ᵣ}, lᵣ=1, 2, . . . , r, for the transmission of the PDSCH.

The dimension of raw e_{r,l}_{ᵣ} can be very large depending on the number of CSI-RS ports and the number of subbands, which can make the AE model and training complex. Accordingly, H may be further pre-processed to have reduced dimension compared to the raw eigenvectors per layer based on feature extraction of the eigenvectors. Building upon the “Pre-processing for input data to the AE” section, the pre-processing of the channel to extract features of eigenvectors per layer in the beam-delay domain with L SD basis and M delay-taps (through M FD basis), results in a linear combination coefficient tensor of dimensions 2L×number of layers×M, denoted by W₂. In a more specific implementation, values for L and M can be chosen from, for example, 3GPP Rel-16 Type-II pre-processing defined in 3GPP standards such as, for example, 3GPP TS 38.214 (M depends on the value of pᵥ in 3GPP TS 38.214, where v is the layer index). With the above pre-processing, the encoder at the wireless device 22 compresses and quantizes W₂, where the reduced dimension of W₂ can lead to reduced AE model size and lower training complexity. The feedback of NZCs of W₂ contributes to substantial overhead for Type-II, which can be reduced leveraging feedback through an AE.

The above pre-processing for eigenvectors requires the wireless device 22 to explicitly feedback L SD and M FD basis back to the network node 16 as part of the uplink CSI report in the UCI. Accordingly, the indices of the L SD and M FD basis are encoded into bits, denoted as b_{model}, and reported to the network node 16, as part of the uplink CSI report. Based on the above, the processing of the channel to produce the CSI report in the UCI to generate the precoders for each transmitted layer through the autoencoder (AE) is shown in FIG. 15. As used herein for one or more embodiments, the per-layer input of the encoder is called eigenvectors. However, the term eigenvector is used in a broad sense that incorporates different ways for the wireless device 22 to extract precoding information for different layers.

Based on the above, a standardized format of CSI report (e.g., what to report, and how to report) is essential so that the wireless device 22 can efficiently compress and report the CSI, and then the network node 16 can correctly retrieve the CSI according to the reported CSI. Accordingly, one or more embodiments describe reporting mechanisms (what quantities to report and how to report them) for the AI-based implicit CSI feedback based on the eigenvector decomposition of the estimated channel per transmission layer based on RI.

### Methods for CQI Calculation for AI-Based CSI Report

In legacy CSI reporting, the CQI indicates a desired MCS that can be calculated based on an assumption of a multi-antenna transmission hypothesis that is selected from a codebook of precoding matrices. The wireless device 22 selects a preferred hypothesis and reports the corresponding PMI, RI, etc. to the network or network node 16, when the PMI is configured to be reported.

Alternatively, for non-PMI based CSI reporting (configured with non-PMI-PortIndication), the CQI can be calculated based on the selected CSI-RS ports and rank. In both alternatives, both network/network node 16 and wireless device 22 have common knowledge of the transmission hypothesis reference (e.g., PMI, RI, selected CSI-RS ports) that is used to calculate the CQI.

However, for AI-based CSI reporting, there is no transmission hypothesis reference or a codebook to use for such reporting, since the output from AE-decoder (assuming at the network/network node side), which is what the network/network node side assumes to be reflecting a transmission hypothesis that is not known to the AE-encoder side unless the training is ideal, i.e., the loss between the input and output of the AE is zero.

Hence, how to calculate the CQI at the wireless device 22 where the network node 16 will be able to interpret the CQI for AI-CSI has been an open problem. Methods for calculating the CQI and the associated signaling are described in one or more embodiments.

One or more embodiments may be divided into two categories, depending on whether a target CSI is reported by the wireless device to the network node 16 (or more general from the encoder side to the decoder side).

### When a Target CSI is Reported

A target CSI could be reported during the data collection/model training or monitoring phase, where the target CSI is used for the network/network node 16 to train the AI/ML model or to monitor any performance drift of the AI/ML model being used for CSI reporting. For example, the target CSI is used by the network node 16 to interpret the CQI.

When a target CSI is reported, both wireless device 22 and network node 16 know the target CSI, then CQI can be calculated in a number of different ways, depending on what a target CSI is.

Target CSI being an Explicit Channel Tensor

In this case, the target CSI is an explicit channel tensor in a given domain (e.g., antenna-frequency domain, beam-delay domain, or beam-delay-doppler domain), potentially with reduced dimensionality compared to the raw channel.

In one embodiment, a transmission hypothesis is used at the wireless device 22 side and the CQI is computed using this transmission hypothesis. The hypothesis may be given by an entry in a defined intermediate precoding matrix codebook, and thus yield a hypothesis/reference PMI (potentially also with CRI, RI). This hypothesis is calculated based on the target CSI, potentially with relevant side information (e.g., b_{model} in FIG. 15), then the CQI is calculated based on the hypothesis/reference PMI (potentially also with CRI, RI).

The hypothesis/reference PMI may or may not be reported to the network node 16 although the set of possible transmission hypotheses is known at the wireless device and network node 16 side, e.g., by a standardized 3GPP description.

For example, the NR Type I codebook can serve as the intermediate transmission hypothesis codebook. The wireless device 22 computes the target CSI, and then computes the PMI from the Type I codebook and assumes this PMI in the hypothesis when computing the CQI. The wireless device 22 then reports the AI-CSI based on the same target CSI and reports the CQI along with the AI-CSI.

When the hypothesis/reference PMI is not reported by the network node 16, the network node 16 can derive this hypothesis/reference PMI based on the reported target CSI, potentially with relevant side information (e.g., b_{model} in FIG. 15). The wireless device 22 may report CRI and/or RI to assist the network node 16 in finding the hypothesis/reference PMI.
In one or more embodiments, the network node 16 configures parameters for generating the hypothesis/reference PMI. Such parameters may include, e.g., type of PMI (e.g., Type I codebook, Type/eType/feType II codebook, or a beam index), codebook parameters (e.g., the number of SD and FD basis, subband size, etc.). The configuration can either be RRC, MAC-CE, DCI or combination of them.

In another embodiment, a number of CSI-RS ports (potentially also with CRI, RI) are selected based on the target CSI, potentially with relevant side information (e.g., b_{model} in FIG. 15), then the CQI is calculated based on the selected CSI-RS ports (potentially also with CRI, RI). The selected ports may or may not be reported by the wireless device 22. When the selected ports are not reported by the wireless device 22, the network node 16 can determine the selected ports based on the reported target CSI. The wireless device 22 may report CRI and/or RI to assist the network in finding the selected CSI-RS ports.
In one or more embodiments, the network configures parameters for calculating the CQI. Such parameters may include, for example, the CSI-RS resource, CSI-RS ports and rank that the wireless device 22 assumes when calculating the CQI. The configuration can either be RRC, MAC-CE, DCI or combination of them.

In yet another embodiment, the wireless device 22 reports a new type of CQI that is not tied with any block error rate (BLER) target. Such CQI value may reflect channel quality, e.g., in terms of signal-to-noise-plus-interference ratio (SINR), then the network node 16 can use the value to determine DL transmission schemes (e.g., scheduling of users, calculating precoding matrix, etc.).
In one or more embodiments, a new CQI table is introduced, where each entry in the table reflects a certain channel quality, e.g., a quantized SINR value.
In one or more embodiments, the network node 16 configures parameters for the CQI calculation, e.g., frequency granularity, CQI table to be used for quantizing the CQI values, etc.
   Target CSI being Representatives of the Channel

Representatives of the channel includes but are not limited to the following:
PMI that is calculated based on the measured/estimated channel.
Eigenvectors of the measured/estimated channel.

In such cases, the CQI can be calculated directly based on the target CSI, potentially with relevant side information (e.g., b_{model} in FIG. 15). For example, if PMI is the target CSI, then the CQI can be calculated based on the PMI. If the eigenvector is the target CSI, then the CQI can be calculated assuming that the eigenvectors are used for precoding. The transmission rank that is used for calculating the CQI may be reported to the network node 16 together with the target CSI, or it can be inferred from the reported target CSI.

In another embodiment, the CQI can be calculated based on a hypothesis/reference PMI, where the hypothesis/reference PMI is derived from the target CSI in a standardized manner.
For example:
   If the target CSI is a PMI calculated by using the strongest L=12 beams and M=10 taps, and a quantization using 6 bits for the amplitude and 9 bits for the complex phase of each linear combination coefficient, then the hypothesis/reference CSI may be derived by sub-selecting the strongest L=8 beams and M=7 taps and using a quantization with 3 bits for the amplitude and 4 bits for the complex phase of each linear combination coefficient.
   If the target CSI consists of eigenvectors of the measured/estimated channel, then the hypothesis/reference PMI can be a beam- and delay-reduced approximation of the target CSI.
In one or more embodiments, the network node 16 configures parameters for calculating this hypothesis/reference CSI. The configuration may be direct configuration of parameters, or implicit configuration giving relations to parameters connected with target CSI. The configuration can either be RRC, MAC-CE, DCI or combination of them. For example:
   In a direct configuration the network node 16 may configure the wireless device 22 to use L=8 beams for the reference/hypothesis CSI.
   In an indirect configuration the network may configure the wireless device to use p=0.7 strongest taps of the target CSI.

### When a Target CSI is not Reported

In some cases, the target CSI is not reported by the wireless device 22 to the network node 16, for example, during the inference phase. Hence, even if the wireless device 22 generates target CSI and then calculates CQI based on it, the network node 16 may not know what is the actual CQI (e.g., may not know to interpret the reported CQI) if the network node 16 transmits PDSCH with a precoder based on the decoder output, since the network node 16 has no exact information on the target CSI.

Despite the above, the wireless device 22 calculates the CQI based on the target CSI, potentially with relevant side information. Take the architecture in FIG. 15 as an example, the CQI therein should be calculated based on e_{r,l}_{ᵣ} and b_{model}, and potentially any other side information that is relevant, such as CRI or selected CSI-RS ports. Then methods for calculating the CQI are the same as described in the “Target CSI being representatives of the channel” and “Target CSI being an explicit channel tensor” section.

Since the network node 16 may not be able to perfectly reconstruct the reported CSI, e.g., ê_{r,l}_{ᵣ}≠e_{r,l}_{ᵣ}. Then, there is a mismatch in CQI even if the network node 16 precodes exactly based on the reconstructed CSI (e.g., ê_{r,l}_{ᵣ} plus any relevant side information, such as b_{model}, CRI). Hence, a mechanism for adjusting the CQI offset is needed.

In one embodiment, the network node 16 learns the CQI offset according to previously received data, such as training data, model monitoring data, and/or, ACK/NACK statistics. Then the learned CQI offset is added to the wireless device 22 reported CQI, when the network node 16 performs PDSCH transmission decisions, such as scheduling, precoding.

In another embodiment, the wireless device 22 reports the CQI offset to the network, so the network can adjust the reported CQI with the reported offset. The CQI offset may be reported periodically or semi-persistently with the same periodicity or with a larger periodicity comparing to the configured CSI report periodicity. For example, the CQI offset may be reported in every n-th CSI report, where n≥1 is a network configured parameter. Alternatively, the CQI offset may also be reported dynamically, which can be triggered by DL control signaling, for example, via DCI.

In yet another embodiment, the wireless device 22 calculates CQI based on the hypothesis/reference PMI, potentially with relevant side information. With reference to the architecture in FIG. 15 as an example, this hypothesis/reference PMI may not be equal to neither e_{r,l}_{ᵣ} nor ê_{r,l}_{ᵣ}. However, given that the transformation from e_{r,l}_{ᵣ} to hypothesis/reference PMI is specified and configured by the network node 16, and that the network node 16 can observe the difference between e_{r,l}_{ᵣ} and ê_{r,l}_{ᵣ} (and thus also between ê_{r,l}_{ᵣ} and hypothesis/reference PMI) in the training and/or model monitoring, it can still learn the CQI offset and add it to the wireless device 22 reported CQI.

### Introducing a New Term Hypothesis CSI

In 3GPP standardization, a new term hypothesis CSI (H-CSI) can be introduced to unify the CQI calculation procedure for AI-based CSI. The H-CSI includes the hypothesis/reference PMI and any side information, such as CRI, RI, b_{model}, that is needed for calculating CQI for AI-based CSI report. H-CSI can be defined for different phases in a life-cycle of an AI/ML model, such as data collection, training, monitoring, inference. Then, the wireless device 22 calculates CSI parameters (if reported) assuming the following dependencies between CSI parameters (if reported).
LI is calculated conditioned on the reported CQI, H-CSI, RI and CRI
CQI shall be calculated conditioned on the reported H-CSI, RI and CRI.
H-CSI shall be calculated conditioned on the reported RI and CRI
RI shall be calculated conditioned on the reported CRI.

In one embodiment the H-CSI can be understood as the hypothesis/reference PMI described above.

Hence, one or more embodiments, describe methods for calculating CQI where the CQI is calculated based on a hypothetical precoder, while the hypothetical precoder is calculated based on the target CSI, potentially with relevant side information. In one or more embodiments, a CQI offset is added by the network/network node to the reported CQI by the wireless device.

One or more embodiments advantageously provides a solution to the problem on what can be assumed about CQI in AI/ML-based CSI reporting. It also provides possibilities to have multiple definitions of Target CSI, while maintaining a clear hypothesis about what CQI means.

### SOME EXAMPLES

Example A1. A network node 16 configured to communicate with a wireless device 22 (WD 22), the network node 16 configured to, and/or comprising a radio interface 62 and/or comprising processing circuitry 68 configured to:
receive a machine learning, ML-based channel state information, CSI, report that includes a channel quality indicator, CQI, that is based on at least one of:
   a transmission hypothesis; and
   a target CSI; and
perform autoencoder-based decoding of the ML-based CSI report.

Example A2. The network node 16 of Example A1, wherein the CQI is based on a hypothetical precoder that is calculated based on the target CSI.

Example A3. The network node 16 of Example A1, wherein the processing circuitry 68 is further configured to configure parameters for generating a hypothesis CSI.

Example A4. The network node 16 of Example A1, wherein the transmission hypothesis corresponds to an entry in an intermediate precoding matrix codebook.

Example A5. The network node 16 of Example A4, wherein the transmission hypothesis is one of a hypothesis CSI and hypothesis precoder matrix indicator, PMI.

Example A6. The network node 16 of Example A1, wherein the processing circuitry 68 is further configured to:
receive a reporting of the target CSI; and
train an ML model based on the target CSI, the ML model being associated with the CSI reporting.

Example A7. The network node 16 of Example A1, wherein the target CSI is a channel tensor in a predefined domain.

Example B1. A method implemented in a network node 16 that is configured to communicate with a wireless device 22, the method comprising:
receiving a machine learning, ML-based channel state information, CSI, report that includes a channel quality indicator, CQI, that is based on at least one of:
   a transmission hypothesis; and
   a target CSI; and
performing autoencoder-based decoding of the ML-based CSI report.

Example B2. The method of Example B1, wherein the CQI is based on a hypothetical precoder that is calculated based on the target CSI.

Example B3. The method of Example B1, further comprising configuring parameters for generating a hypothesis CSI.

Example B4. The method of Example B1, wherein the transmission hypothesis corresponds to an entry in an intermediate precoding matrix codebook.

Example B5. The method of Example B4, wherein the transmission hypothesis is one of a hypothesis CSI and hypothesis precoder matrix indicator, PMI.

Example B6. The method of Example B1, further comprising:
receiving a reporting of the target CSI; and
training an ML model based on the target CSI, the ML model being associated with the CSI reporting.

Example B7. The method of Example B1, wherein the target CSI is a channel tensor in a predefined domain.

Example C1. A non-transitory computer readable medium 72 storing program instructions that, when executed by a processor 70, configure the processor 70 to implement the method of any one of Examples B1 to B7.

Example D1. A wireless device 22 (WD 22) configured to communicate with a network node 16, the WD 22 configured to, and/or comprising a radio interface 82 and/or processing circuitry 84 configured to:
perform channel measurements;
generate a machine learning, ML-based channel state information, CSI, report based on the channel measurements, the ML-based CSI report including a channel quality indicator, CQI, that is based on at least one of:
   a transmission hypothesis; and
   a target CSI; and
cause transmission of the ML-based CSI report.

Example D2. The wireless device 22 of Example D1, wherein the CQI is based on a hypothetical precoder that is calculated based on the target CSI.

Example D3. The wireless device 22 of Example D1, wherein the processing circuitry 84 is further configured to receive parameters for generating a hypothesis CSI.

Example D4. The wireless device 22 of Example D1, wherein the transmission hypothesis corresponds to an entry in an intermediate precoding matrix codebook.

Example D5. The wireless device 22 of Example D4, wherein the transmission hypothesis is one of a hypothesis CSI and hypothesis precoder matrix indicator, PMI.

Example D6. The wireless device 22 of Example D1, wherein the processing circuitry 84 is further configured to:
report the target CSI for training an ML model associated with the CSI reporting.

Example D7. The wireless device 22 of Example D1, wherein the target CSI is a channel tensor in a predefined domain.

Example E1. A method implemented by a wireless device 22 (WD 22) that is configured to communicate with a network node 16, the method comprising:
performing channel measurements;
generating a machine learning, ML-based channel state information, CSI, report based on the channel measurements, the ML-based CSI report including a channel quality indicator, CQI, that is based on at least one of:
   a transmission hypothesis; and
   a target CSI; and
causing transmission of the ML-based CSI report.

Example E2. The method of Example E1, wherein the CQI is based on a hypothetical precoder that is calculated based on the target CSI.

Example E3. The method of Example E1, further comprising receiving parameters for generating a hypothesis CSI.

Example E4. The method of Example E1, wherein the transmission hypothesis corresponds to an entry in an intermediate precoding matrix codebook.

Example E5. The method of Example E4, wherein the transmission hypothesis is one of a hypothesis CSI and hypothesis precoder matrix indicator, PMI.

Example E6. The method of Example E1, further comprising reporting the target CSI for training an ML model associated with the CSI reporting.

Example E7. The method of Example E1, wherein the target CSI is a channel tensor in a predefined domain.

Example F1. A non-transitory computer readable medium 88 storing program instructions that, when executed by a processor 86, configure the processor to implement the method of any one of Examples E1 to E7.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
AE Auto Encoder
AI Artificial Intelligence
CSI Channel State Information
CSI-RS Channel State Information Reference Signal
CQI Channel Quality Indicator
CRI CSI-RS Resource Indicator
DCI Downlink Control Information
eType II CB Enhanced Type II codebook
FD Frequency Domain
feType II CB Further enhanced Type II codebook
gNB A radio base station in NR
LCM Life-cycle management
LI Layer Indicator
LSB Least significant bit
ML Machine Learning
MSB Most significant bit
MU-MIMO Multi User-Multiple Input, Multiple Output
NR New Radio
PMI Precoder Matrix Indicator
PUSCH Physical Uplink Shared Channel
PUCCH Physical Uplink Control Channel
RI Rank Indicator
RRC Radio Resource Control
SRS Sounding Reference Signal
SD Spatial Domain
TD Time Domain
T-CSI Target CSI
UCI Uplink Control Information
UE User Equipment

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented by a wireless device, the wireless device being configured to communicate with a network node, the method comprising:
performing channel measurements; and
generating a channel state information, CSI, report based on the channel measurements, the CSI report including a channel quality indicator, CQI, that is based on a target CSI.

2. The method of claim 1, wherein the target CSI is a common reference for the wireless device to calculate the CQI and for the network node to interpret the CQI in non-codebook based CSI.

3. The method of claim 1, further comprising calculating a hypothetical precoder based on the target CSI, the CQI being calculated based on the hypothetical precoder.

4. The method of claim 1, wherein the CSI report is based on a transmission hypothesis associated with at least one hypothetical transmission parameters, the CQI being an expected CQI for communications using the at least one hypothetical transmission.

5. The method of claim 1, further comprising receiving at least one parameter for calculating the CQI, the at least one parameter comprises at least one of a CSI-reference signal, CSI-RS, resource, rank or CSI-RS port.

6. The method of claim 1, further comprising reporting the target CSI to the network node.

7. The method of claim 6, wherein the target CSI is reported to the network node during a model training phase or monitoring phase.

8. The method of claim 6, wherein the target CSI is a channel tensor in a predefined domain.

9. The method of claim 8, wherein the predefined domain is one of:
an antenna-frequency domain;
beam-delay domain; or
beam-delay-doppler domain.

10. The method of claim 6, wherein the target CSI is one of a calculated hypothetical precoder or a plurality of eigenvectors of the channel measurements.

11. The method of claim 1, wherein the target CSI is unreported to the network node by the wireless device (22).

12. The method of claim 11, further comprising:
determining a CQI offset corresponding to a CQI mismatch between the wireless device and network node; and
reporting the CQI offset to the network node.

13. The method of claim 1, wherein the CSI report is a machine learning, ML, based CSI report.

14. A wireless device configured to communicate with a network node, the wireless device configured to:
perform channel measurements; and
generate a channel state information, CSI, report based on the channel measurements, the CSI report including a channel quality indicator, CQI, that is based on a target CSI.

15. The wireless device of claim 14, wherein the target CSI is a common reference for the wireless device to calculate the CQI and for the network node to interpret the CQI in non-codebook based CSI.

16. The wireless device of claim 14, wherein the wireless device is further configured to calculate a hypothetical precoder based on the target CSI, the CQI being calculated based on the hypothetical precoder.

17. The wireless device of claim 14, wherein the CSI report is based on a transmission hypothesis associated with at least one hypothetical transmission parameters, the CQI being an expected CQI for communications using the at least one hypothetical transmission.

18. The wireless device of claim 14, wherein the wireless device is further configured to receive at least one parameter for calculating the CQI, the at least one parameter comprises at least one of a CSI-reference signal, CSI-RS, resource, rank or CSI-RS port.

19.-26. (canceled)

27. A method implemented by a network node, the network node being configured to communicate with a wireless device, the method comprising:
receiving a channel state information, CSI, report, the CSI report comprising a channel quality indicator, CQI, that is based on a target CSI; and
performing autoencoder-based decoding based on the CSI report and CQI for deriving a precoder for transmission to the wireless device.

28.-39. (canceled)

40. A network node configured to communicate with a wireless device, the network node configured to:
receive a channel state information, CSI, report, the CSI report comprising a channel quality indicator, CQI, that is based on a target CSI; and
perform autoencoder-based decoding based on the CSI report and CQI for deriving a precoder for transmission to the wireless device.

41.-52. (canceled)
